(19) United States
(12) Patent Application Publication
(10) Pub. No.: US 2004/0027607 A1
(43) Pub. Date: Feb. 12, 2004

(54) Image forming apparatus, image forming method, image input apparatus, image input method, image processing apparatus, image processing method, and image processing program

(75) Inventor: Hidefumi Nishigai, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 10/374,086

(22) Filed: Feb. 27, 2003

(30) Foreign Application Priority Data
Aug. 12, 2002 (JP) P2002-234759

(51) Int. Cl. G06K 1/00; G06F 15/00; G06F 17/10; H04N 1/00

(52) U.S. Cl. 358/1.15; 358/405; 701/301

(57) ABSTRACT

When a communication control section of an image forming apparatus receives image information, an administration information acquiring section detects administration information from GPS information or the like received through an antenna. An administration information generating section generates the detected administration information in the form of an image. An administration information adding section adds the image indicating the administration information to the image information. An image forming section forms an image added with the administration information.

The present disclosure relates to the subject matter contained in Japanese Patent Application No. 2002-234759 filed on Aug. 12, 2002, which is incorporated herein by reference in its entirety.

### BACKGROUND OF THE INVENTION

1. Field of the Invention

The present invention relates to an image forming apparatus, an image forming method, an image input apparatus, an image input method, an image processing apparatus, an image processing method, and an image processing program. The invention particularly relates to an image forming apparatus, an image forming method, an image input apparatus, an image input method, an image processing apparatus, an image processing method, and an image processing program for administering originality of a print and installation of the apparatus itself.

2. Description of the Related Art

Generally, when a laser printer is used for printing a certificate such as a resident's card, a printed form difficult to forge is prepared in advance and used under sever administration so as to secure the originality of the certificate.

As a method for securing originality of a printed material outputted from a laser printer or the like and suppressing forging the print, there is a method in which a specific design or pattern is printed in the background on the printed material.

However, if the pattern is a pattern that can be set desirably by a customer, the pattern can be forged easily by use of another similar printer. Accordingly, it is not adequate to use such an outputted printed material as an original of a certificate or the like.

Further, a specific code peculiar to each printer can be embedded therein to print a pattern peculiar to the printer. However, it is necessary to administer where each printer is installed. When a printer is resold, it becomes difficult to trace a location where the printer is installed. Thus, this method is not practical.

In addition, there is another method in which a clock is built in a printer and time information is added to a printed material so as to be used for identifying a forger. However, when the time is changed on purpose or at fault, it becomes difficult to identify the forger.

### SUMMARY OF THE INVENTION

It is therefore an object of the invention to provide an image forming apparatus, an image forming method, an image input apparatus, an image input method, an image processing apparatus, an image processing method, and an image processing program, which are useful for identifying a forger when a printed material or image information, which is a base of the print printed material, has been forged.

According to a first aspect of the invention, there is provided an image forming apparatus for forming an image in accordance with image information. The image forming apparatus includes an administration information acquiring section for acquiring administration information, an administration information adding section for adding the acquired administration information in the form of an image to image information, which is a subject of image formation, an image forming section for forming an image based on the image information to which the administration information is added.

According to a second aspect of the invention, in the image forming apparatus of the first aspect, the administration information is position specifying information for specifying a position of the image forming apparatus.

According to a third aspect of the invention, in the e image forming apparatus of the second aspect, only when the administration information acquiring section can acquire the position specifying information, the image forming section is allowed to form the image.

According to a fourth aspect of the invention, the image forming apparatus of the second aspect, further includes an encryption section for encrypting the position specifying information. The administration information adding section adds the encrypted position specifying information to the image information.

According to a fifth aspect of the invention, in the image forming apparatus of the first aspect, the administration information is time information. The administration information acquiring section acquires the time information from external.

According to a sixth aspect of the invention, in the image forming apparatus of the fifth aspect, the time information is time information contained in radio wave. The administration acquiring section receives the radio wave to acquire the time information.

According to a seventh aspect of the invention, in the image forming apparatus of the fifth aspect, only when the administration information acquiring section can acquire the time information, the image forming section is allowed to form the image.

According to an eighth aspect of the invention, there is provided an image input apparatus for inputting image information. The image input apparatus includes an image information input section for inputting the image information, an administration information acquiring section for acquiring administration information, an administration information adding section for adding the acquired administration information to the image information, which is input by the image information input section, and an image information output section for outputting the image information to which the administration information is added.

According to a ninth aspect of the invention, in the image input apparatus of the eighth aspect, the administration information is position specifying information for specifying a position of the image input apparatus.

According to a tenth aspect of the invention, in the image input apparatus of the ninth aspect, when the image input apparatus receives from external at least one of an instruction for inputting the image information by the image information input section and an instruction for outputting the image information by the image information output section, the administration information acquiring section acquires the position specifying information.

According to an eleventh aspect of the invention, in the image input apparatus of the eighth aspect, the administration information is time information. The administration information acquiring section acquires the time information from external.

According to a twelfth aspect of the invention, in the image input apparatus of the eleventh aspect, the time information is time information contained in radio wave. The administration acquiring section receives the radio wave to acquire the time information.

According to a thirteenth aspect of the invention, in the image input apparatus of the eleventh aspect, when the image input apparatus receives from external at least one of an instruction for inputting the image information by the image information input section and an instruction for outputting the image information by the image information output section, the administration information acquiring section acquires the position specifying information.

According to a fourteenth aspect of the invention, there is provided an image processing apparatus includes an administration information acquiring section for acquiring administration information, an administration information adding section for adding the acquired administration information to image information, and an image information output section for outputting the image information, which the administration information is added to, to an image forming unit for performing image formation.

According to a fifteenth aspect of the invention, in the image processing apparatus of the fourteenth aspect, the administration information is position specifying information for specifying at least one of a position of the image processing apparatus and a position of the image forming unit.

According to a sixteenth aspect of the invention, in the image processing apparatus of the fifteenth aspect, when the image processing apparatus receives from external an instruction for outputting the image information by the image information output section, the administration information acquiring section acquires the position specifying information.

According to a seventeenth aspect, in the image processing apparatus of the fourteenth aspect, the administration information is time information. The administration information acquiring section acquires the time information from external.

According to an eighteenth aspect of the invention, there is provided an image forming method including acquiring administration information of an image forming apparatus, adding the acquired administration information in the form of an image to image information, which is a subject of image formation, and forming an image based on the image information to which the administration information is added. The image forming apparatus conduct the forming step.

According to a nineteenth aspect of the invention, in the image forming method of the eighteenth aspect, the administration information is position specifying information for specifying a position of the image forming apparatus.

According to a twentieth aspect of the invention, in the image forming method of the eighteenth aspect, the administration information is time information. The administration information acquiring section acquires the time information from external of the image forming apparatus.

According to a twenty-first aspect of the invention, in the image forming method of the twentieth, the time information is time information contained in radio wave. In the acquiring step, the radio wave is received to acquire the time information.

According to a twenty-second aspect of the invention, there is provided an image input method including inputting image information, acquiring administration information of an image input apparatus, adding the acquired administration information to the inputted image information, and outputting the image information to which the administration information is added. The image input apparatus performs the inputting step.

According to a twenty-third aspect of the invention, in the image input method of the twenty-second aspect, the administration information is position specifying information for specifying a position of the image inputting apparatus.

According to a twenty-fourth aspect of the invention, in the image input method of the twenty-second aspect, the administration information is time information. In the acquiring step, the time information is acquired from external of the image inputting apparatus.

According to a twenty-fifth aspect of the invention, in the image input method of the twenty-fourth aspect, the time information is time information contained in radio wave. In the acquiring step, the radio wave is received to acquire the time information.

According to a twenty-sixth aspect of the invention, there is provided an image processing method including acquiring administration information of an image forming apparatus, adding the acquired administration information in the form of an image to image information, which is a subject of image formation, and outputting the image information, which the administration information is added to, to the image forming apparatus.

According to a twenty-seventh aspect of the invention, in the image processing method of the twenty-sixth aspect, the administration information is position specifying information for specifying a position of the image forming apparatus.

According to a twenty-eighth aspect of the invention, in the image processing method of the twenty-sixth aspect, the administration information is time information. In the acquiring step, the time information is acquired from external of the image forming apparatus.

According to a twenty-ninth aspect of the invention, there is provided an image processing program causing a computer to perform image processing including acquiring position specifying information for specifying at least one of a position of an image forming apparatus for forming an image and a position of the computer, adding the acquired position specifying information to image information, which is a subject of image formation, and outputting the image information, which the administration information is added to, to the image forming apparatus.

### BRIEF DESCRIPTION OF THE DRAWINGS

FIG. 1 is a block diagram showing an example of the schematic configuration of an image forming apparatus 1 according to an embodiment of the invention.

FIGS. 2A to 2C are views showing examples of images 13 added with administration information.

FIG. 3 is a flow chart showing a routine of processing to be executed when the image forming apparatus 1 forms an image.

FIG. 4 is a flow chart showing a routine of processing in which the image forming apparatus 1 acquires administration information periodically, and processing for forming an image is allowed only when the administration information can be acquired.

FIG. 5 is a block diagram showing an example of the schematic configuration of an image input apparatus 17 according to an embodiment of the invention.

FIG. 6 is a flow chart showing a routine of processing to be executed by a printer driver for adding administration information of a client 11 to image information.

### DETAILED DESCRIPTION OF THE PREFERRED EMBODIMENTS

Detailed description will be made below on embodiments of an image forming method, an image forming apparatus, an image forming program, an image input method and an image input apparatus according to the invention with reference to the accompanying drawings.

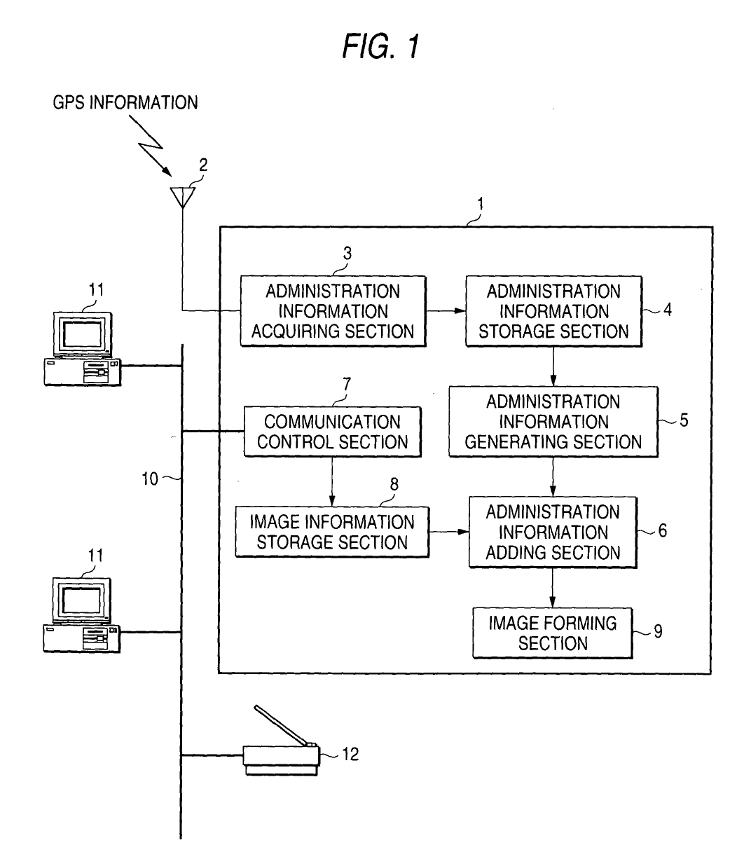

FIG. 1 is a block diagram showing an example of the schematic configuration of an image forming apparatus 1 according to an embodiment of the invention.

As shown in FIG. 1, the image forming apparatus 1 includes an antenna 2, an administration information acquiring section 3, an administration information storage section 4, an administration information generating section 5, an administration information adding section 6, a communication control section 7, an image information storage section 8 and an image forming section 9. When the communication control section 7 connects to a network 10, the image forming apparatus 1 is connected to clients 11 and a scanner 12 through the network 10.

Here, the antenna 2 receives GPS (Global Positioning System) information or the like.

The administration information acquiring section 3 acquires administration information (e.g. position information or time information) from the GPS information or the like received through the antenna 2. In addition, the administration information acquiring section 3 calculates a difference in time information between a plurality of satellites so as to determine position information. To this end, the administration information acquiring section 3 can correct the time of a clock built therein.

The administration information storage section 4 temporarily stores the administration information acquired by the administration information acquiring section 3.

The administration information generating section 5 generates the administration information in the form of an image. Incidentally, the administration information generating section 5 is possible to adopt the configuration in which the administration information generating section 5 encrypts the administration information in the form of two-dimensional codes or the like, and generates the encrypted administration information in the form of an image. That is, when the encrypted administration information is printed, it becomes difficult to forge the administration information. Here, by use of asymmetrical cryptograph (using different keys for encryption and decryption), it becomes more difficult to forge the administration information.

The administration information adding section 6 adds the image indicating the administration information to image information received by the communication control section 7.

The communication control section 7 receives image information transmitted from the client 11 or the scanner 12.

The image information storage section 8 temporarily stores the image information received by the communication control section 7.

The image forming section 9 forms an image in accordance with the image information to which the image indicating the administration information by the administration information adding section 6 is added.

Incidentally, the following configuration may be applied to the administration information generating section 5. That is, the administration information generating section 5 may generate an image indicating the administration information in the form of a hidden image, and add the generated hidden image indicating the administration information to the image information. Incidentally, technique to generate a hidden image and add the hidden image to a document has been known. For example, when the hidden image is generated in pale yellow, it becomes difficult to recognize the hidden image with human eyes.

In addition, the following configuration may be adopted. That is, an installation position of the image forming apparatus 1 is specified on the basis of the position information acquired by the administration information acquiring section 3. Then, text information included in image information to be printed may be converted into language used in the installation position.

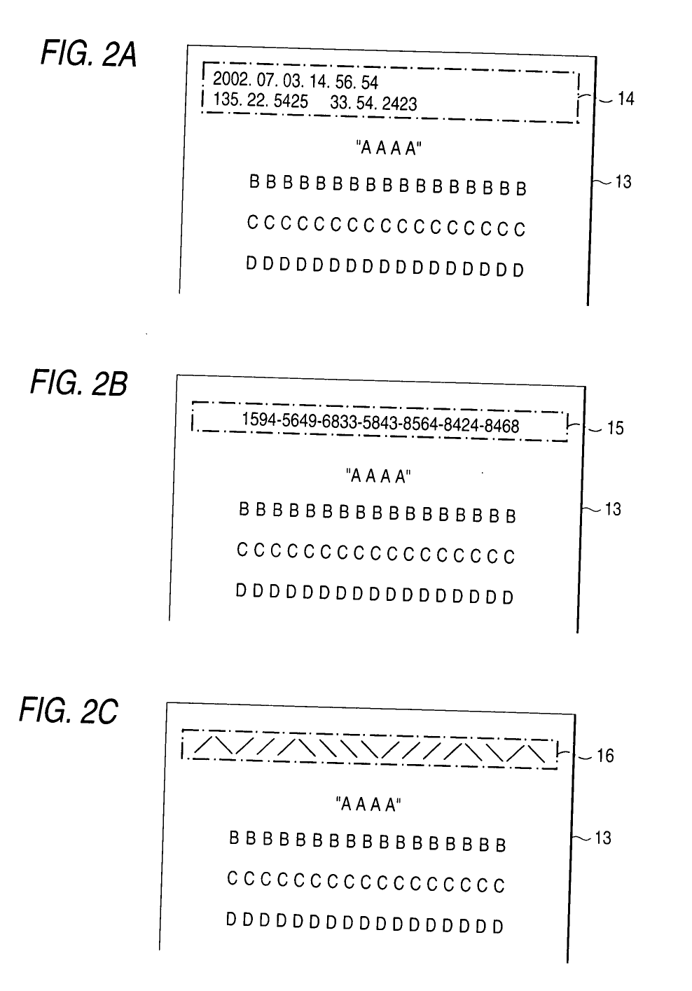

FIGS. 2A to 2C are views showing examples of images 13 to which the administration information is added.

FIG. 2A is a view showing an example of an image 13 to which position information and time information is added as administration information in the form of characters. As shown in FIG. 2A, administration information 14 is added to the image 13. Here, in the administration information 14, “2002.07.03.14.56.54” indicates the time information while “135.22.5425” and “33.54.2423” indicate the position information.

FIG. 2B is a view showing an example of an image 13 to which the encrypted administration information is added. As shown in FIG. 2B, encrypted administration information 15 (“1594-5649-6833-5843-8564-8424-8468”) is added to the image 13. Here, to acquire the administration information of the image forming apparatus 1, which has formed the image 13, the encrypted administration information 15 may be decrypted.

FIG. 2C is a view showing an example of an image 13 to which the administration information formed in two-dimensional code is added (such as glyph code or two-dimensional bar code). As shown in FIG. 2C, two-dimensionally coded administration information 16 (e.g. glyph coded “ [symbol] [symbol] [symbol] ”) is added to the image 13. Here, to acquire the administration information of the image forming apparatus 1, which has formed the image 13, the two-dimensionally coded administration information 16 may be decoded.

Accordingly, when and where the image forming apparatus 1 formed the image 13 can be confirmed easily on the basis of the administration information. Thus, even if no administration is performed on each apparatus, where the apparatus, which has printed the copy, is installed can be identified easily.

Here, a configuration may be adopted so that the administration information 14, the encrypted administration information 15 or the two-dimensionally coded administration information 16 shown in FIG. 2A-2C is generated in the form of a hidden image, and the generated hidden image indicating the administration information is added to image information. That is, since the hidden image is usually difficult to be recognized visually, it is seen visually that only a main body of an image is printed on a paper. However, when the image to which the hidden image is added is converted into electronic data by a scanner, the hidden image can be extracted.

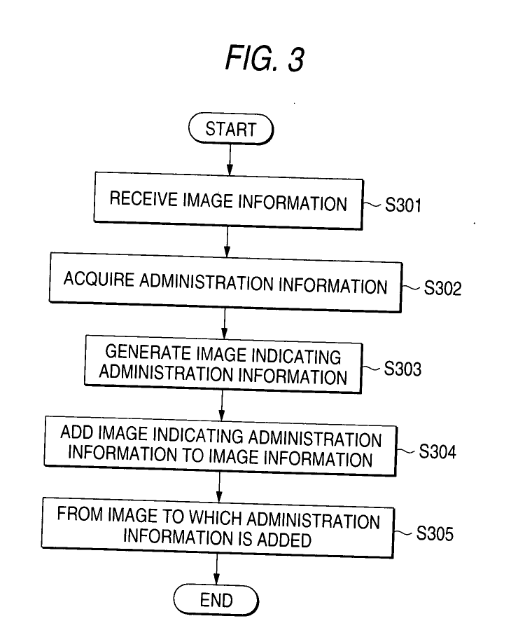

Next, a routine of processing to be carried out when the image forming apparatus 1 forms an image will be described with reference to the flow chart shown in FIG. 3.

When the communication control section 7 of the image forming apparatus 1 receives image information (Step S301), administration information is acquired from GPS information or the like received through the antenna 2 (Step S302). An image indicating the acquired administration information is generated (Step S303). The image indicating the administration information is added to the image information (Step S304). An image to which the administration information is added is formed (Step S305). Then, the routine of processing is terminated.

Incidentally, in Step S303, when the image indicating the administration information is generated, it is also possible to encrypt or two-dimensionally code the administration information. In addition, in Step S303, it is also possible to generate the image indication the administration information in the form of a hidden image.

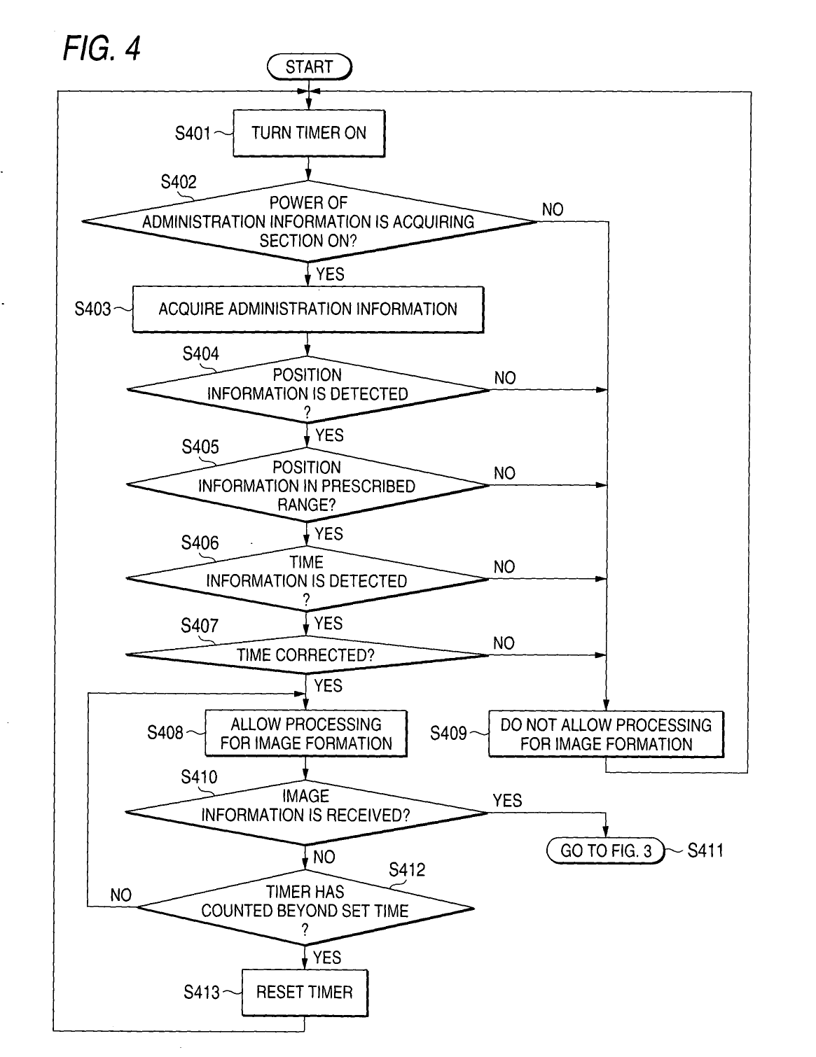

Next, a routine of processing for the image forming apparatus 1 to acquire administration information periodically and to be allowed to execute the processing for forming an image only when the administration information can be acquired will be described with reference to a flow chart shown in FIG. 4.

To acquire administration information periodically, a timer is turned on (Step S401). Confirmation is made as to whether power of the administration information acquiring section 3 is on or off (Step S402). When the power of the administration information acquiring section 3 is on (YES in Step S402), administration information is acquired from GPS information or the like received through the antenna 2 (Step S403).

Next, confirmation is made as to whether position information included in the administration information is detected correctly or not (Step S404). When the position information is detected correctly (YES in Step S404), confirmation is made as to whether the position information is in a prescribed range or not (Step S405). When the position information is in the prescribed range (YES in Step S405), confirmation is made as to whether time information included in the administration information is detected correctly or not (Step S406). When the time information is detected correctly (YES in Step S406), the time of the clock in the administration information acquiring section 3 is corrected (Step S407). When the time of the clock has been corrected (YES in step S407), the processing for forming an image is allowed (Step S408).

Incidentally, when the power of the administration information acquiring section is off (NO in Step S402), when the position information is not detected correctly (NO in Step S404), when the position information is out of the prescribed range (NO in Step S405), when the time information is not detected correctly (NO in Step S406), or when the time of the clock cannot be corrected (NO in Step S407), the processing for forming an image is not allowed (Step S409) and the acquisition of administration information is started again (the routine of processing returns to Step S401).

While the processing for forming an image is being allowed, assume that image information is received (YES in Step S410). Then, the flow chart of FIG. 3 showing the routine of processing for the image forming apparatus to form an image is executed (Step S411).

On the other hand, when no image information is received (NO in Step S410) or when the timer has counted beyond a set time (YES in Step S412), the timer is reset (Step S413), and the acquisition of administration information is started again (the routine of processing returns to Step S401).

Accordingly, the processing for forming an image is allowed only when the administration information can be acquired. Thus, the administration information can be always added to the image so that the originality of any printed material can be secured. Further, since the prescribed range is set in the position information, this method can be also applied to a configuration for inhibiting the processing for forming an image when the apparatus has been stolen or smuggled.

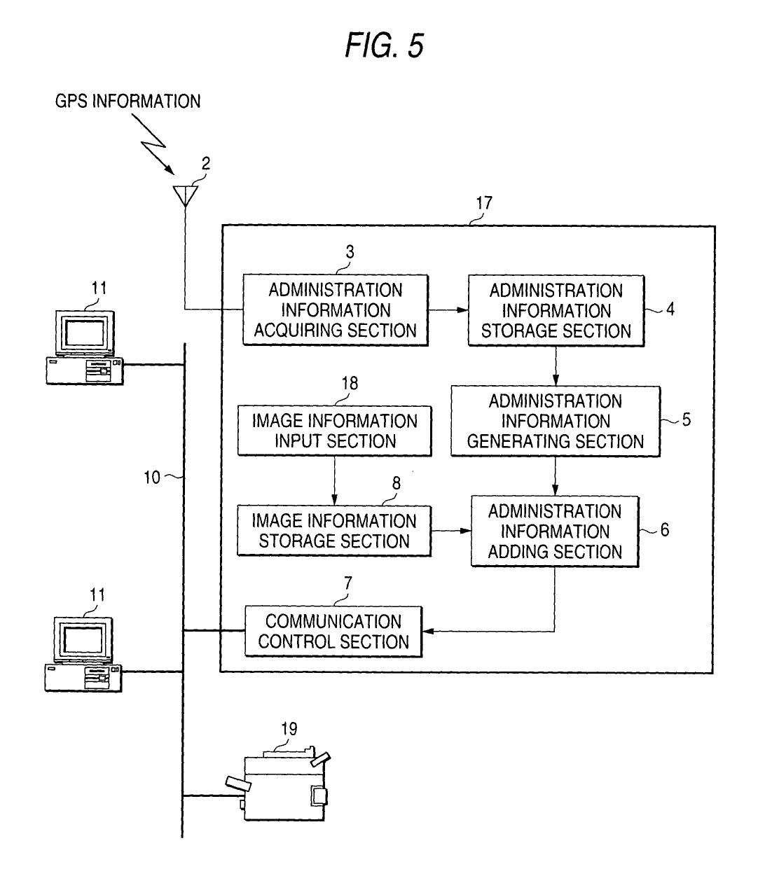

FIG. 5 is a block diagram showing an example of the schematic configuration of an image input apparatus 17 according to an embodiment of the invention.

As shown in FIG. 5, the image input apparatus 17 according to the invention includes an antenna 2, an administration information acquiring section 3, an administration information storage section 4, an administration information generating section 5, an administration information adding section 6, a communication control section 7, an image information storage section 8 and an image information input section 18. When the communication control section 7 connects to a network 10, the image information input apparatus 17 is connected to clients 11 and a printer 19 through the network 10.

Here, the image information input section 18 converts read image information into electronic data.

Incidentally, the antenna 2, the administration information acquiring section 3, the administration information storage section 4, the administration information generating section 5, the administration information adding section 6, the communication control section 7 and the image information storage section 8 have functions similar to those in the embodiment of the image forming apparatus 1 shown in FIG. 1.

Here, when the image information input section 18 inputs image information by reading a manuscript or in another method, the administration information acquiring section 3 acquires administration information from GPS information or the like received through the antenna 2. The administration information generating section 5 generates the administration information in the form of an image. The administration information adding section 6 adds the administration information generated in the form of an image to the image information stored in the image information storage section 8 in the form of a digital watermark. Here, the administration information may be added to the image information not in the form of an image but in header information or the like.

Then, the image information to which the image indicating the administration information is added is outputted (transmitted) to the client 11 through the communication control section 7.

Incidentally, the image input apparatus 17 may also adopt the following configuration in the same manner as the image forming apparatus 1. That is, the image input apparatus 17 acquires administration information periodically and allows to perform output processing only when the administration information can be acquired.

In the embodiments of the image forming apparatus 1 and the image input apparatus 17, the configuration in which administration information is detected from GPS information by way of example. However, the invention is applicable to the configuration in which administration information is specified from information other than GPS information. For example, PHS information may be used or access point information in a wireless LAN may be used. Further, when the image forming apparatus or the image input apparatus is connected to a network or the like, the IP address of the image forming apparatus or the image input apparatus may be used as position specifying information. This is because the position of the apparatus can be specified from the IP address to some extent.

Next, description will be made on a printer driver for adding administration information of the client 11 such as IP address thereof, and transmitting the administration information to a printer 19 when the printer 19 prints image information stored in the client 11.

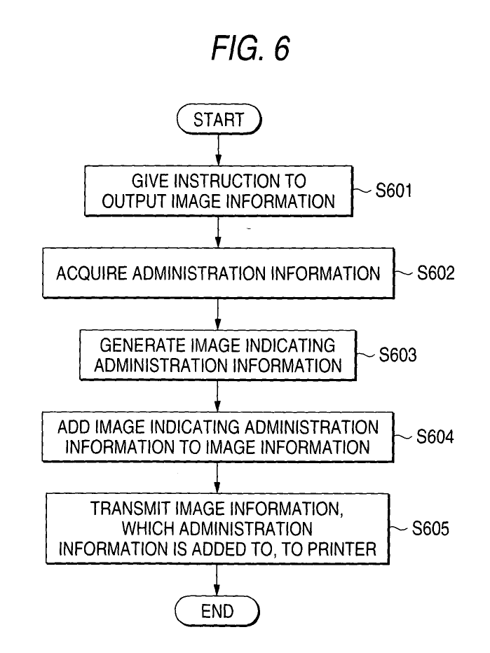

Here, a routine of processing to be executed by the printer driver for adding the administration information of the client 11 to image information will be described with reference to a flow chart shown in FIG. 6.

When an instruction to output image information is given from the client 11 (Step S601), administration information such as the IP address of the client 11 is acquired (Step S602). An image indicating the acquired administration information is generated (Step S603). The image indicating the administration information is added to the image information (Step S604). The image information to which the administration information is added is transmitted to the image forming apparatus 19 (Step S605). Then, the routine of processing is terminated.

Incidentally, in Step S602, the configuration in which administration information is acquired from GPS information can be adopted if the client 11 has a configuration capable of receiving GPS information or the like. Here, position information to be acquired may be information indicating either the position of the image forming apparatus (printer 19) or the position of the apparatus (client 11) itself. It is more preferable that the position information of both the imaging forming apparatus and the apparatus itself is acquired and added to image information.

In addition, the following configuration maybe adopted. That is, a radio wave clock is built in the image forming apparatus 1 or the image input apparatus 17 according to the invention. Time information is extracted from the radio wave clock. The time information as administration information is added to an image.

Here, the antenna receives a standard frequency broadcast. Time information is acquired from the received standard frequency broadcast. The time of the radio wave clock is corrected on the basis of the acquired time information. Then, only when the time of the radio wave clock can be corrected, the processing for forming an image is allowed.

As described above, according to the invention, there is an effect that the invention is useful in identifying a forger when a printed material or image information, which is a base of the print, has been forged.

What is claimed is:

1. An image forming apparatus for forming an image in accordance with image information, the image forming apparatus comprising:
an administration information acquiring section for acquiring administration information;
an administration information adding section for adding the acquired administration information in the form of an image to image information, which is a subject of image formation; and
an image forming section for forming an image based on the image information to which the administration information is added.

2. The image forming apparatus according to claim 1,
wherein the administration information is position specifying information for specifying a position of the image forming apparatus.

3. The image forming apparatus according to claim 2,
wherein only when the administration information acquiring section can acquire the position specifying information, the image forming section is allowed to form the image.

4. The image forming apparatus according to claim 2, further comprising an encryption section for encrypting the position specifying information,
wherein the administration information adding section adds the encrypted position specifying information to the image information.

5. The image forming apparatus according to claim 1,
wherein the administration information is time information; and
wherein the administration information acquiring section acquires the time information from external.

6. The image forming apparatus according to claim 5,
wherein the time information is time information contained in radio wave; and
wherein the administration acquiring section receives the radio wave to acquire the time information.

7. The image forming apparatus according to claim 5, wherein only when the administration information acquiring section can acquire the time information, the image forming section is allowed to form the image.

8. An image input apparatus for inputting image information, the image input apparatus comprising:
an image information input section for inputting the image information;
an administration information acquiring section for acquiring administration information;
an administration information adding section for adding the acquired administration information to the image information, which is input by the image information input section; and
an image information output section for outputting the image information to which the administration information is added.

9. The image input apparatus according to claim 8, wherein the administration information is position specifying information for specifying a position of the image input apparatus.

10. The image input apparatus according to claim 9,
wherein when the image input apparatus receives from external at least one of an instruction for inputting the image information by the image information input section and an instruction for outputting the image information by the image information output section, the administration information acquiring section acquires the position specifying information.

11. The image input apparatus according to 8,
wherein the administration information is time information; and
wherein the administration information acquiring section acquires the time information from external.

12. The image input apparatus according to claim 11,
wherein the time information is time information contained in radio wave; and
wherein the administration acquiring section receives the radio wave to acquire the time information.

13. The image input apparatus according to claim 11, wherein when the image input apparatus receives from external at least one of an instruction for inputting the image information by the image information input section and an instruction for outputting the image information by the image information output section, the administration information acquiring section acquires the position specifying information.

14. An image processing apparatus comprising:
an administration information acquiring section for acquiring administration information;
an administration information adding section for adding the acquired administration information to image information; and
an image information output section for outputting the image information, which the administration information is added to, to an image forming unit for performing image formation.

15. The image processing apparatus according to claim 14, wherein the administration information is position specifying information for specifying at least one of a position of the image processing apparatus and a position of the image forming unit.

16. The image processing apparatus according to claim 15, wherein when the image processing apparatus receives from external an instruction for outputting the image information by the image information output section, the administration information acquiring section acquires the position specifying information.

17. The image processing apparatus according to claim 14,
wherein the administration information is time information; and
wherein the administration information acquiring section acquires the time information from external.

18. An image forming method comprising:
acquiring administration information of an image forming apparatus;
adding the acquired administration information in the, form of an image to image information, which is a subject of image formation; and
forming an image based on the image information to which the administration information is added,
wherein the image forming apparatus conduct the forming step.

19. The image forming method according to claim 18, wherein the administration information is position specifying information for specifying a position of the image forming apparatus.

20. The image forming method according to claim 18,
wherein the administration information is time information; and
wherein the administration information acquiring section acquires the time information from external of the image forming apparatus.

21. The image forming method according to claim 20,
wherein the time information is time information contained in radio wave; and
wherein in the acquiring step, the radio wave is received to acquire the time information.

22. An image input method comprising:
inputting image information;
acquiring administration information of an image input apparatus;
adding the acquired administration information to the inputted image information; and
outputting the image information to which the administration information is added,
wherein the image input apparatus performs the inputting step.

23. The image input method according to claim 22, wherein the administration information is position specifying information for specifying a position of the image inputting apparatus.

24. The image input method according to claim 22,
wherein the administration information is time information; and
wherein in the acquiring step, the time information is acquired from external of the image inputting apparatus.

25. The image input method according to claim 24,
wherein the time information is time information contained in radio wave; and
wherein in the acquiring step, the radio wave is received to acquire the time information.

26. An image processing method comprising:
acquiring administration information of an image forming apparatus;
adding the acquired administration information in the form of an image to image information, which is a subject of image formation; and
outputting the image information, which the administration information is added to, to the image forming apparatus.

27. The image processing method according to claim 26, wherein the administration information is position specifying information for specifying a position of the image forming apparatus.

28. The image processing method according to claim 26,
wherein the administration information is time information; and
wherein in the acquiring step, the time information is acquired from external of the image forming apparatus.

29. An image processing program causing a computer to perform image processing comprising:
acquiring position specifying information for specifying at least one of a position of an image forming apparatus for forming an image and a position of the computer;
adding the acquired position specifying information to image information, which is a subject of image formation; and
outputting the image information, which the administration information is added to, to the image forming apparatus.
